(19) United States
(12) Patent Application Publication
(10) Pub. No.: US 2025/0293280 A1
(43) Pub. Date: Sep. 18, 2025

(54) FLOW BATTERY

(71) Applicant: VRB Energy Inc., Grand Cayman (KY)

(72) Inventors: Hao Yang, Tongzhou District (CN); Zhiling Zhao, Tongzhou District (CN); Hedi Ma, Tongzhou District (CN); Huichao Liu, Tongzhou District (CN); Qiming Ge, Tongzhou District (CN)

(21) Appl. No.: 18/750,299

(22) Filed: Jun. 21, 2024

(30) Foreign Application Priority Data
Mar. 12, 2024 (CN) 202410279593.3

(51) Int. Cl. H01M 8/18; H01M 8/04276

(52) U.S. Cl. CPC H01M 8/188; H01M 8/04276

(57) ABSTRACT

Provided herein is a flow battery, provided with a primary mating protrusion, a primary mating recess, a first liquid inlet channel, a first liquid outlet channel, a second liquid inlet channel, and a second liquid outlet channel on opposite sides of any adjacent frames, wherein the primary mating protrusion and the primary mating recess form a primary seal mating line, the first liquid inlet channel, a first cavity, and the first liquid outlet channel are communicated, and the second liquid inlet channel, a second cavity and the second liquid outlet channel are communicated; and at least one of the first liquid inlet channel, first liquid outlet channel, second liquid inlet channel, and second liquid outlet channel is produced by separation by the primary seal mating line. At least one of the first liquid inlet channel, first liquid outlet channel, second liquid inlet channel, and second liquid outlet channel is separated between adjacent frames by the primary seal mating line, having advantages such as a simple production process, a low production cost, and a good sealing effect.

### RELATED APPLICATIONS

This application claims priority to Chinese Patent Application No. 202410279593.3, filed Mar. 12, 2024, and titled FLOW BATTERY, which is incorporated herein by reference in its entirety.

### TECHNICAL FIELD

The present application relates to, but is not limited to, the technical field of electric pile devices, and particularly to a flow battery.

### BACKGROUND

A flow battery, as an essential component in the new clean energy industry, is an important medium in the field of photovoltaic and wind energy to connect power grids to user terminals. The flow battery stores electrical energy from grids and outputs it to user terminals, so its stability, safety, electrical energy conversion rate, and storage capacity are continuously studied and developed by respective battery production facilities.

In conventional flow batteries, a seal ring or a seal rubber is used for sealing liquid passages through which electrolytic solutions flow, with problems of complicated production processes and high production costs.

### SUMMARY

The present application provides a flow battery, in which a flow channel through which an electrolytic solution flows is easily manufactured at a low cost, and a good seal effect is achieved for the flow channel.

The embodiment in the present application provides a flow battery comprising a plurality of subunits arranged in sequence, each of the subunits comprising a first electrode having a first cavity, a second electrode having a second cavity, a frame, a partition plate, and a proton exchange membrane, the proton exchange membrane being provided at an inner hole of the frame, the first electrode being located at a first side of the proton exchange membrane, the second electrode being located at a second side of the proton exchange membrane, and the partition plate being provided at a side of one of the first electrode and the second electrode facing away from the other one of the first electrode and the second electrode, wherein the first electrode and the second electrode at opposite sides of any adjacent sub-units are separated by the partition plate, opposite sides of any adjacent frames are provided with a primary mating protrusion, a primary mating recess, a first liquid inlet channel, a first liquid outlet channel, a second liquid inlet channel and a second liquid outlet channel, the primary mating protrusion and the primary mating recess form a primary seal mating line, the first liquid inlet channel, the first cavity and the first liquid outlet channel are communicated, the second liquid inlet channel, the second cavity and the second liquid outlet channel are communicated, and at least one of the first liquid inlet channel, the first liquid outlet channel, the second liquid inlet channel and the second liquid outlet channel is produced by separation by the primary seal mating line.

In some exemplary embodiments, the primary mating protrusion includes a first primary mating protrusion, a second primary mating protrusion, a third primary mating protrusion, and a fourth primary mating protrusion, the primary mating recess includes a first primary mating recess, a second primary mating recess, a third primary mating recess, and a fourth primary mating recess, the first primary mating protrusion and the first primary mating recess form a first primary seal mating line, the second primary mating protrusion and the second primary mating recess form a second primary seal mating line, the third primary mating protrusion and the third primary mating recess form a third primary seal mating line, the fourth primary mating protrusion and the fourth primary mating recess form a fourth primary seal mating line, the first liquid inlet channel is produced by separation by the first primary seal mating line, the first liquid outlet channel is produced by separation by the second primary seal mating line, the second liquid inlet channel is produced by separation by the third primary seal mating line, and the second liquid outlet channel is produced by separation by the fourth primary seal mating line.

In some exemplary embodiments, the first primary mating recess, the second primary mating recess, the third primary mating recess, and the fourth primary mating recess are located at a first side of the frame, and the first primary mating protrusion, the second primary mating protrusion, the third primary mating protrusion, and the fourth primary mating protrusion are located at a second side of the frame.

In some exemplary embodiments, a flow equalizing structure is provided between the first liquid inlet channel and the first cavity.

In some exemplary embodiments, a flow equalizing structure is provided between the first cavity and the first liquid outlet channel.

In some exemplary embodiments, a flow equalizing structure is provided between the second liquid inlet channel and the second cavity.

In some exemplary embodiments, a flow equalizing structure is provided between the second cavity and the second liquid outlet channel.

In some exemplary embodiments, opposite sides of any adjacent frames are further provided with a secondary mating protrusion and a secondary mating recess, the secondary mating protrusion and the secondary mating recess form an annular sub-seal mating line, and the primary mating protrusion, the primary mating recess, the first liquid inlet channel, the first liquid outlet channel, the second liquid inlet channel, the second liquid outlet channel, the first electrode, and the second electrode are all located within a region surrounded by the sub-seal mating line.

In some exemplary embodiments, the flow battery further includes a first insulating plate and a second insulating plate, wherein the first insulating plate is located at a first side of the second insulating plate, a plurality of the subunits are located between the first insulating plate and the second insulating plate, a first liquid inlet channel, a first liquid outlet channel, a primary mating protrusion, a primary mating recess, a secondary mating protrusion, and a secondary mating recess are also provided between the first insulating plate and a frame adjacent thereto, and a second liquid inlet channel, a second liquid outlet channel, a primary mating protrusion, a primary mating recess, a secondary mating protrusion, and a secondary mating recess are also provided between the second insulating plate and a frame adjacent thereto.

In some exemplary embodiments, the primary mating protrusion has a height of 4 mm ˜12 mm , and a width of 1.5 mm ˜3 mm , and the primary mating recess has a depth of 4 mm ˜12 mm , and a width of 2 mm ˜3.5 mm .

In some exemplary embodiments, the secondary mating protrusion has a height of 4 mm ˜12 mm and a width of 1.5 mm ˜3 mm , and the secondary mating recess has a depth of 4 mm ˜12 mm and a width of 2 mm ˜3.5 mm .

In some exemplary embodiments, the frame includes a first frame and a second frame, one of the first frame and the second frame is provided with a positioning recess and the other one is provided with a positioning protrusion, one of the first frame and the second frame is further provided with an annular sealing rib, the positioning protrusion is disposed in the positioning recess, the sealing rib presses a periphery of the proton exchange membrane against the other one of the first frame and the second frame, the primary mating recess and the primary mating protrusion are located outside a region surrounded by the second frame and on the first frame, and the partition plate is provided at a side of the second frame opposite to the first frame.

In some exemplary embodiments, an elastic deformation structure for adjusting a size of the second frame is provided at a corner of the second frame.

In some exemplary embodiments, the positioning projection has a height of 1.5 mm ˜3.5 mm and a width of 1.5 mm ˜3 mm , and the positioning recess has a depth of 1.5 mm ˜3.5 mm and a width of 2 mm ˜3.5 mm .

In the technical solution in the embodiments of the present application, the first electrode and second electrode at opposite sides of any adjacent sub-units are separated by the partition plate, preventing a short circuit for the first electrode and the second electrode; the primary mating protrusion and the primary mating recess form the primary sealing mating line with the effects of a good sealing effect, a simple production process and a low production cost; and due to the effects, at least one of the first liquid inlet channel, first liquid outlet channel, second liquid inlet channel and second liquid outlet channel, which are produced between adjacent frames by separation by the primary sealing mating line, also has the effects.

### BRIEF DESCRIPTION OF THE DRAWINGS

FIG. 1 is an exploded structural schematic view of a flow battery according to some embodiments;

FIG. 2 is an exploded structural schematic view of the flow battery shown in FIG. 1;

FIG. 3 is an exploded structural schematic view of a sub-unit in FIG. 1;

FIG. 4 is a perspective structural schematic view of a first frame in FIG. 1;

FIG. 5 is a sectional structural schematic view after assembling a plurality of sub-units in FIG. 1;

FIG. 6 is an enlarged structural schematic view of portion A in FIG. 5;

FIG. 7 is a front structural schematic view of the second frame ii FIG. 1;

FIG. 8 is a rear structural schematic view of the second frame in FIG. 1;

FIG. 9 is a front structural schematic view of an example of a first end plate or a second end plate in FIG. 1;

FIG. 10 is a front structural schematic view of an example of a first end plate or a second end plate in FIG. 1, with reinforcing ribs provided on the first end plate or second end plate; and

FIG. 11 is an enlarged structural schematic view of portion B in FIG. 5.

The relation between reference numerals and components is as following:

100 a first electrode; 200 a second electrode; 310 a first frame; 311 a positioning recess; 320 a second frame; 321 a positioning protrusion; 322 an elastic deformation structure; 323 a sealing rib; 400 a partition plate; 500 a proton exchange membrane; 600 a protective film; 710 a first liquid inlet channel; 711 a first liquid inlet hole; 720 a first liquid outlet channel; 721 a first outlet channel; 730 a second liquid inlet channel; 731 a second liquid inlet hole; 740 a second liquid outlet channel; 741 a second liquid outlet hole; 750 a first primary mating protrusion; 751 a first primary mating recess; 752 a first primary seal mating line; 760 a second primary mating protrusion; 761 a second primary mating recess; 762 a second primary seal mating line; 770 a third primary mating protrusion; 771 a third primary mating recess; 772 a third primary seal mating line; 780 a fourth primary mating protrusion; 781 a fourth primary mating recess; 782 a fourth primary seal mating line; 790 a flow equalizing structure; 810 a secondary mating protrusion; 820 a secondary mating recess; 830 a secondary seal mating line; 910 a first insulating plate; 920 a second insulating plate; 930 a first end plate; 940 a second end plate; 950 a first power drawing plate; 960 a second power drawing plate; 970 a screw; 980 a spring.

### DETAILED DESCRIPTION

The technical solutions in the embodiments of the present application will be clearly described below with reference to the figures in the embodiments. Obviously, the described embodiments are only some of the embodiments of the present application. The scope of protection of the present application encompass all other embodiments obtained by those skilled in the art based on the embodiments of the present application without inventive effort.

It should be noted that all directional indication (such as upper, lower, left, right, front, rear.) in the embodiments of the present application is only used to explain the relative positional relation, movement, etc. between components in a specific attitude (as shown in figures). If the specific attitude changes, the directional indication changes accordingly.

In addition, terms such as “first”, “second”, and the like in the present application are for descriptive purposes only and are not to be construed as indicating or implying relative importance thereof or implicitly indicating the number of technical features indicated. Thus, a feature defined by “first”, or “second” may explicitly or implicitly include at least one such feature. In the description of the present application, “a plurality of” means at least two, for example, two, three, etc., unless specifically defined otherwise.

In the present application, unless specifically indicated and defined otherwise, the terms “connection”, “fixing” and the like should be understood in a broad sense, for example, “fixing” may be a fixed connection, a detachable connection, or an integrated connection, a mechanical connection, or an electrical connection, and “connection” may be a direct connection, an indirect connection with an intermediary component, communication between two components, or an interaction between two components, unless specifically defined otherwise. For a person of ordinary skill in the art, the specific meanings of the above terms in the present application may be understood according to practical conditions.

In addition, technical solutions in embodiments of the present application may be combined by a person of ordinary skill, and when a combination of technical solutions is inconsistent or cannot be implemented, it should be considered that such a combination does not exist and is not within the scope of protection of the present application.

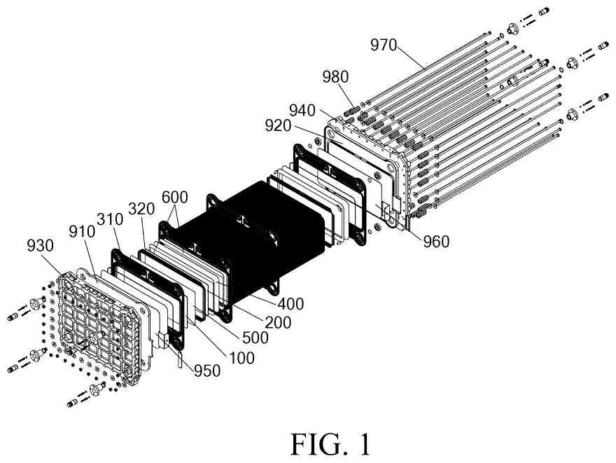

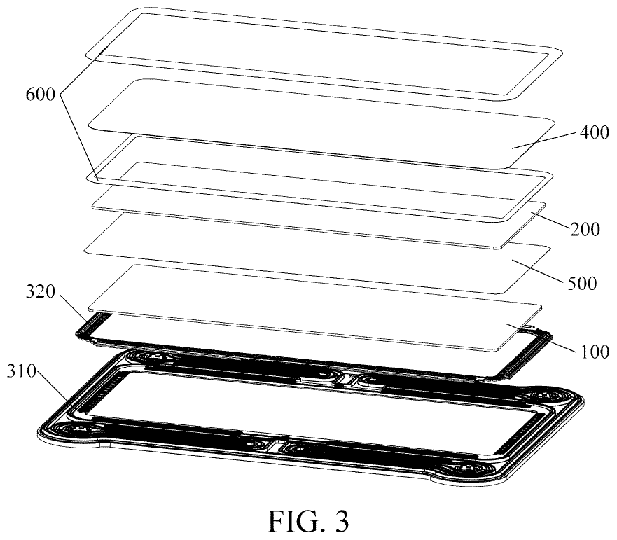

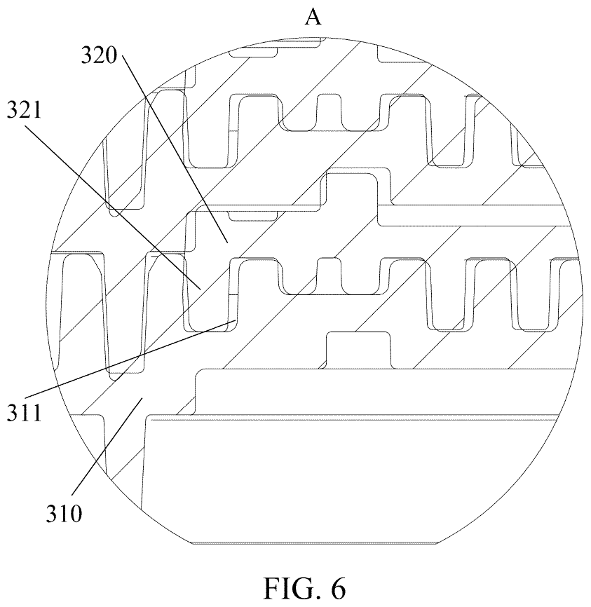

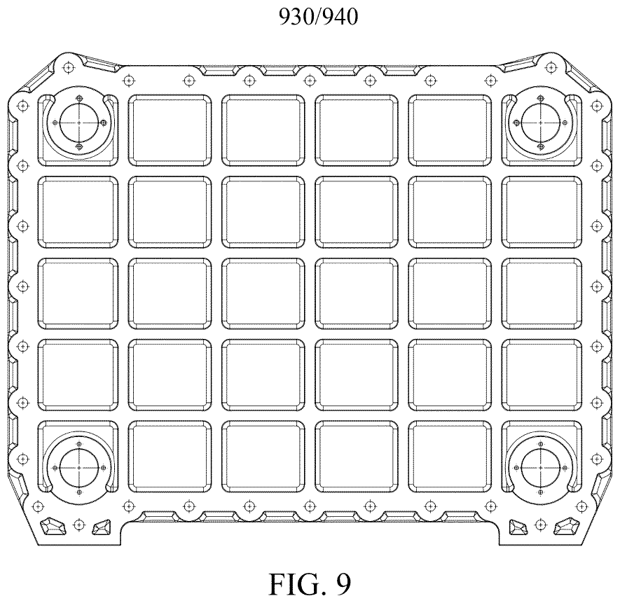

As shown in FIGS. 1 to 10, the flow battery of the embodiments of the present application comprises a plurality of sub-units arranged in sequence, each sub-unit comprising a first electrode having a first cavity 100, a second electrode having a second cavity; 200, a frame, a partition plate 400, and a proton exchange membrane 500, the proton exchange membrane 500 is provided at an inner hole of the frame, a first electrode 100 is located at a first side of the proton exchange membrane 500, a second electrode 200 is located at a second side of the proton exchange membrane 500, the partition plate 400 is provided at a side of one of the first electrode 100 and the second electrode 200 facing away from the other one of the first electrode 100 and the second electrode 200, wherein the first electrode 100 and the second electrode 200 at the opposite sides of any adjacent sub-units are separated by the separating plate 400, opposite sides of any adjacent frames are provided with a primary mating protrusion, a primary mating recess, a first liquid inlet channel 710, a first liquid outlet channel 720, a second liquid inlet channel 730, and a second liquid outlet channel 740, the primary mating protrusion and the primary mating recess form a primary seal mating line, the first liquid inlet channel 710, the first cavity, and first liquid outlet channel 720 are communicated, the second liquid inlet channel 730, the second cavity, and the second liquid outlet channel 740 are communicated, and at least one of the first liquid inlet channel 710, first liquid outlet channel 720, second liquid inlet channel 730, and second liquid outlet channel 740 is produced by separation by the primary seal mating line.

In the flow battery, the first electrode 100 and the second electrode 200 at opposite sides of any adjacent sub-units are separated by the partition plate 400, the partition plate 400 is used to prevent a short circuit for the first electrode 100 and the second electrode 200 on the opposite sides of the adjacent sub-units, the primary mating protrusion and primary mating recess form the primary seal mating line with the effects of a good sealing effect, a simple production process and a low production cost; and due to the effects, at least one of the first liquid inlet channel 710, first liquid outlet channel 720, second liquid inlet channel 730, and second liquid outlet channel 740, which are produced between adjacent frames by separation by the primary seal mating line, also has the effects.

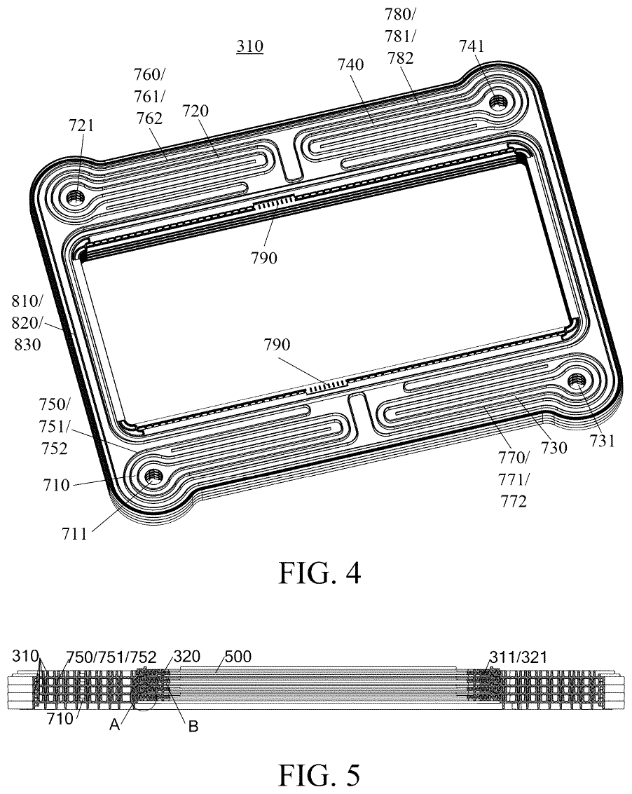

In some exemplary embodiments, as shown in FIGS. 4 and 5, the primary mating protrusion includes a first primary mating protrusion 750, a second primary mating protrusion 760, a third primary mating protrusion 770, and a fourth primary mating protrusion 780, the primary mating recess includes a first primary mating recess 751, a second primary mating recess 761, a third primary mating recess 771, and a fourth primary mating recess 781, the first primary mating protrusion 750 and first primary mating recess 751 form a first primary seal mating line 752, the second primary mating protrusion 760 and second primary mating recess 761 form a second primary seal mating line 762, the third primary mating protrusion 770 and the third primary mating recess 771 form a third primary seal mating line 772, the fourth primary mating protrusion 780 and fourth primary mating recess 781 form a fourth primary seal mating line 782, the first liquid inlet channel 710 is produced by separation by first primary seal mating line 752 (i.e., the first primary seal mating line 752 produces, via separation, the first liquid inlet channel 710 between adjacent frames), the first liquid outlet channel 720 is produced by separation by the second primary seal mating line 762 (i.e., the second primary seal mating line 762 produces, via separation, the first liquid outlet channel 720 between adjacent frames, the second liquid inlet channel 730 is produced by separation by the third primary seal mating line 772 (i.e., the third primary seal mating line 772 produces, via separation, the second liquid inlet channel 730 between adjacent frames), and the second liquid outlet channel 740 is produced by separation by the fourth primary seal mating line 782 (i.e., the fourth primary seal mating line 782 produces, via separation, the second liquid outlet channel 740 between adjacent frames).

Alternatively, the primary mating protrusion includes any one of a first primary mating protrusion 750, a second primary mating protrusion 760, a third primary mating protrusion 770, and a fourth primary mating protrusion 780, the primary mating recesses includes one of a first primary mating recess 751, a second primary mating recess 761, a third primary mating recess 771, and a fourth primary mating recess 781, the primary seal mating line formed by the primary mating protrusion and the primary mating recess in this case only produces, via separation, the first liquid inlet channel 710, the first liquid outlet channel 720, the second liquid inlet channel 730 and the second liquid outlet channel 740; or it may be that the primary mating protrusion comprises any two of the first primary mating protrusion 750, the second primary mating protrusion 760, the third primary mating protrusion 770, and the fourth primary mating protrusion 780, the primary mating recess includes two of the first primary mating recess 751, the second primary mating recess 761, the third primary mating recess 771, and the fourth primary mating recess 781, the primary seal mating line formed by the primary mating protrusion and the primary mating recess in this case produces, via separation, only two of the first liquid inlet channel 710, the first liquid outlet channel 720, the second liquid inlet channel 730, and a second liquid outlet channel 740, or it may be that the primary mating protrusion comprises any three of the first primary mating protrusion 750, the second primary mating protrusion 760, the third primary mating protrusion 770 and the fourth primary mating protrusion 780, the primary mating recess includes three of the first primary mating recess 751, the second primary mating recess 761, the third primary mating recess 771, and the fourth primary mating recess 781, and the primary seal mating line formed by the primary mating protrusion and the primary mating recess mate in this case produces, via separation, only three of the first liquid inlet channel 710, the first liquid outlet channel 720, the second liquid inlet channel 730, and the second liquid outlet channel 740; and all of the above solutions can achieve the object of the present application, with the principle not departing from the design concept of the present application, and shall fall within the scope of protection of the present application with detailed description thereof omitted herein.

In an embodiment, as shown in FIG. 4, the first primary mating recess 751, the second primary mating recess 761, the third primary mating recess 771, and the fourth primary mating recess 781 are located at a first side (e.g., a left side) of the frame, and the first primary mating protrusion 750, the second primary mating protrusion 760, the third primary mating protrusion 770, and the fourth primary mating protrusion 780 are located at a second side (e.g., a right side) of the frame. The frame is provided as a plastic member, and the first primary mating recess 751, the second primary mating recess 761, the third primary mating recess 771, the fourth primary mating recess 781, the first primary mating protrusion 750, the second primary mating protrusion 760, the third primary mating protrusion 770, and the fourth primary mating protrusion 780 are manufactured by an injection molding process, which is simple and highly accurate.

Here, if the first electrode 100 is a positive electrode and the second electrode 200 is a negative electrode, the electrolyte flowing through the first cavity is a positive electrode electrolyte and the electrolyte flowing through the second cavity is a negative electrode electrolyte; and if the second electrode 200 is a positive electrode and the first electrode 100 is a negative electrode, the electrolyte flowing through the second cavity is a positive electrode electrolyte and the electrolyte flowing through the first cavity is a negative electrode electrolyte.

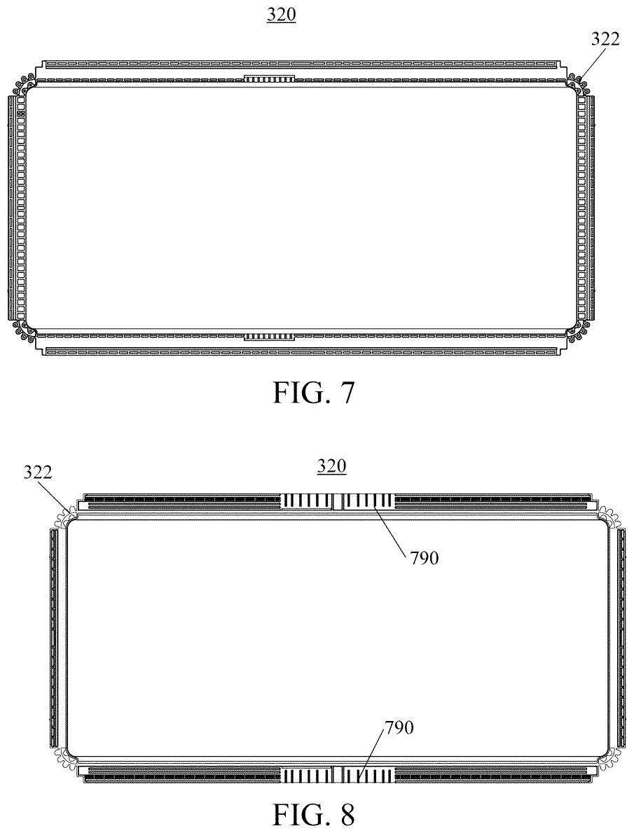

In an embodiment, as shown in FIGS. 4 and 8, a flow equalizing structure 790 is provided between the first liquid inlet channel 710 and the first cavity, a flow equalizing structure 790 is provided between the first cavity and the first liquid outlet channel 720, a flow equalizing structure 790 is provided between the second liquid inlet channel 730 and the second cavity, and a flow equalizing structure 790 is provided between the second cavity and the second liquid outlet channel 7 40, so that the flow rate of the electrolyte into each first cavity is the same and the flow rate of the electrolyte into each second cavity is the same. If the first electrode 100 is a positive electrode and the second electrode 200 is a negative electrode, the electrolyte into the first cavity is a positive electrode electrolyte and the electrolyte into the second cavity is a negative electrode electrolyte; and if the second electrode 200 is a positive electrode and the first electrode 100 is a negative electrode, the electrolyte into the second cavity is a positive electrode electrolyte and the electrolyte into the first cavity is a negative electrode electrolyte.

The flow equalizing structure 790 has a set length of 40 mm ˜80 mm , and a set width of 5 mm ˜20 mm .

In some examples, such as shown in FIG. 4, opposite sides of any adjacent frames are also provided with a secondary mating protrusion 810, and a secondary mating recess 820, the secondary mating protrusion 810 and secondary mating recess 820 form an annular secondary seal mating line 830, the primary mating protrusion, the primary mating recess, the first liquid inlet channel 710, the first liquid outlet channel 720, the second liquid inlet channel 730, the second liquid outlet channel 740, the first electrode 100 and the second electrode 200 are located in a region surrounded by the secondary seal mating line 830. The secondary seal mating line 830 forms second sealing to prevent the leakage of an electrolyte from the flow battery when an electrolyte is leaked from the first liquid inlet channel 710, the first liquid outlet channel 720, the second liquid inlet channel 730, and the second liquid outlet channel 740.

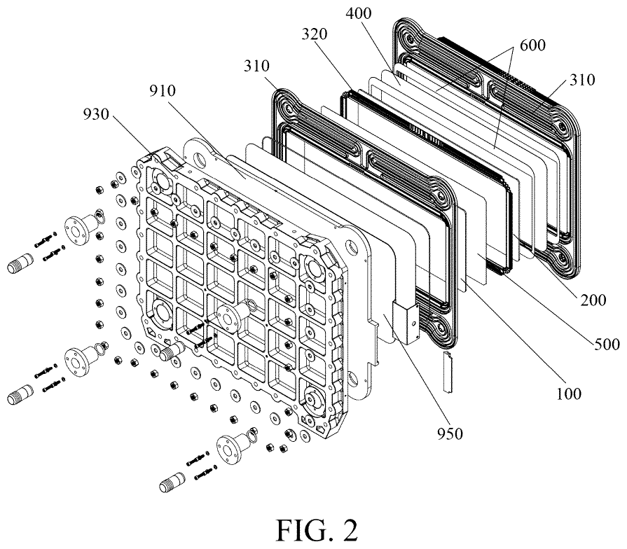

In some examples, as shown in FIGS. 1 and 2, the flow battery further comprises a first insulating plate 910, and a second insulating plate 920, the first insulating plate 910 is located at a first side of the second insulating plate 920, and the plurality of sub-units are located between the first insulating plate 910, and the second insulating plate 920. The first liquid inlet channel 710, the first liquid outlet channel 720, the primary mating protrusion, the primary mating recess, the secondary mating protrusion 810, and the secondary mating recess 820 are also provided between the first insulating plate 910, and its adjacent frame, and the primary seal mating line (formed by the primary mating protrusion and the primary mating recess) produces, via separation, the first liquid inlet channel 710 and the first liquid outlet channel 720. The second liquid inlet channel 730, the second liquid outlet channel 740, the primary mating protrusion, the primary mating recess, the secondary mating protrusion 810, and the secondary mating recess 820 are also provided between the second insulating plate 920, and its adjacent frame, and the primary seal mating line (formed by the primary mating protrusion and the primary mating recess) produces, via separation, the second liquid inlet channel 730 and the second liquid outlet channel 740. A first power drawing plate 950 is provided between the first insulating plate 910 and the plurality of subunits, and a second power drawing plate 960 is provided between the second insulating plate 920 and the plurality of subunits.

As shown in FIG. 4, the first liquid inlet channel 710 and second liquid inlet channel 730 are both located at a lower portion of the frame, and the first liquid inlet hole 711 and a second liquid inlet hole 731 are further provided at the lower portion of the frame, the first liquid inlet hole 711 is communicated with an inlet of the first liquid inlet channel 710, the second liquid inlet hole 731 is communicated with an inlet of the second liquid inlet channel 730, the first liquid outlet channel 720 and second liquid outlet channel 740 are both located at the upper part of the frame, the upper part of the frame is further provided the first liquid outlet hole 721 and the second liquid outlet hole 741, the first liquid outlet channel 720 is communicated with an output of the first liquid outlet channel 720, and the second liquid outlet channel 740 is communicated with an output of the second liquid outlet channel 740.

As shown in FIG. 4, the first liquid inlet channel 710, the second liquid inlet channel 730, the first liquid outlet channel 720, and the second liquid outlet channel 740 have a curved structure, and a set length of 1000 mm ˜2300 mm . The secondary seal mating line 830 has a set length of 8000 mm ˜20000 mm .

The primary mating protrusion has a height of 4 mm ˜12 mm and a width of 1.5 mm ˜3 mm , the primary mating recess has a depth of 4 mm ˜12 mm and a width of 2 mm ˜3.5 mm , and an end face of the primary mating protrusion abuts on an inner end face of the primary mating recess for press-scaling mating.

The secondary mating protrusion 810 has a height of 4 mm ˜12 mm , and a width of 1.5 mm ˜3 mm , the secondary mating recess 820 has a depth of 4 mm ˜12 mm , and a width of 2 mm ˜3.5 mm , and the end face of the secondary mating protrusion 810 abuts on the inner end face of the secondary mating recess 820 for press-scaling.

The inner hole of the frame has a height in a vertical direction of 200 mm ˜500 mm , and a length in a horizontal direction of 500 mm ˜900 mm , the first electrode 100 and second electrode 200 has a height in a vertical direction of 200 mm ˜500 mm , and the first electrode 100 and second electrode 200 has a length in a horizontal direction of 500 mm ˜900 mm , the proton exchange membrane 500 has a height in a vertical direction of 230 mm ˜530 mm , the proton exchange membrane 500 has a length in a horizontal direction of 550 mm ˜950 mm , the partition plate 400 is a bipolar plate having a height in a vertical direction of 230 mm ˜530 mm , and a length in a horizontal direction of 550 mm ˜950 mm .

As shown in FIGS. 1 to 3, protective films 600 are provided around both sides of the bipolar plate, and the protective films 600 have a set width of 20 mm ˜60 mm .

Furthermore, as shown in FIGS. 1, 2, 9, and 10, the flow battery further comprises a first end plate 930 and a second end plate 940 outside the first insulating plate 910 and second insulating plate 920, and after assembling of the first end plate 930, the first insulating plate 910, the plurality of sub-units, the second insulating plate 920 and the second end plate 940, a plurality of screws 970 are provided in the periphery, and a spring 980 is sleeved onto each of the screws 970 for clastic connection.

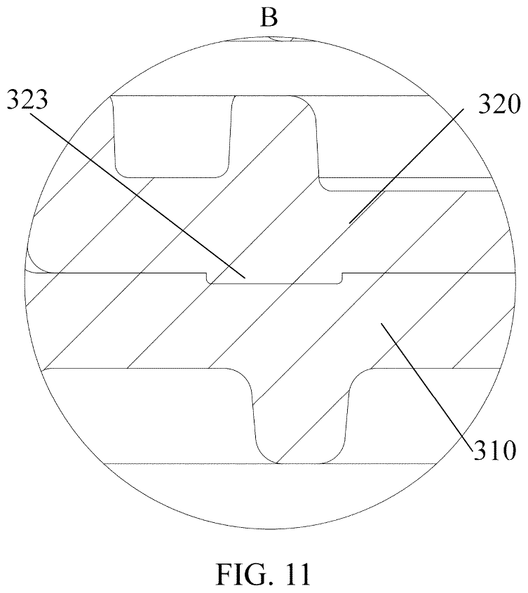

In some examples, as shown in FIGS. 1 to 7, 8, and 11, the frame includes a first frame 310 and a second frame 320, the inner holes of the first frame 310 and second frame 320 has the same set size, the first frame 310 has a height in a vertical direction larger than that of the second frame 320, one of the first frame 310 and second frame 320 is provided with an annular positioning recess 311, the other one is provided with an annular positioning protrusion 321, the positioning protrusion 321 is provided in the positioning recess 311 to position the first frame 310 and second frame 320, the side of the second frame 320 facing the first frame 310 is also provided with an annular sealing ribs 323 (see FIGS. 5 and 11), the scaling rib 323 is located within the region surrounded by the positioning protrusion 321, the sealing rib 323 presses a periphery of the proton exchange membrane 500 against the side of the first frame 310 facing the second frame 320 for sealing and fixing the membrane, and the periphery of the proton exchange membrane 500 has a seal effect between the sealing rib 323 and first frame 310. The primary mating recess and the primary mating protrusion are located outside the region surrounded by the second frame 320, and are on the first frame 310, and the partition plate 400 is provided at a side of the second frame 320 facing away from the first frame 310. Two flow equalizing structures 790 and two flow equalizing structures 790 are provided at upper and lower portions of the side of the first frame 310 facing away from the second frame 320, respectively, and two flow equalizing structures 790 and two flow equalizing 790 are provided at upper and lower portions of the side of the second frame 320 facing away from the first frame 310, respectively.

In some embodiments, the positioning protrusion 321 has a height of 1.5 mm ˜3.5 mm , and a width of 1.5 mm ˜3 mm , the sealing rib 323 has a height of0.1 mm ˜0.5 mm , and a width of 1.5 mm ˜4 mm , and the positioning recess 311 has a depth of 1.5 mm ˜3.5 mm , and a width of 2 mm ˜3.5 mm . The positioning protrusion 321 and the positioning recess 311 are assembled to pre-position the first frame 310 and the second frame 320, and the scaling rib 323 presses the periphery of the proton exchange membrane 500 against the side of the first frame 310 facing the second frame 320 to seal and fix the proton exchange membrane 500. Alternatively, the sealing rib may be provided on the first frame for the object of the present application without departing from the design concept of the application, and such a solutions shall fall within the scope of protection of the application with detailed description thereof omitted herein.

In some examples, as shown in FIG. 7 and FIG. 8, a corner of the second frame 320 is provided with an elastic deformation structure 322 for adjusting the size of the second frame 320 to ensure that the positioning protrusion 321 and the positioning recess 311 can be smoothly assembled together. Alternatively, the second frame 320 may be a rectangular annular frame, and the elastic deformation structure 322 may be provided at each of four corners of the second frame 320, to adjust the length and width of the second frame 320 by the elastic deformation structure 322.

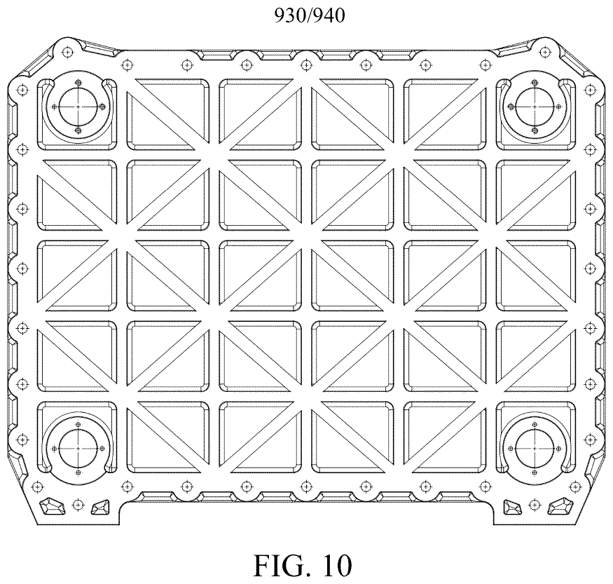

When the number of the plurality of sub-units is larger than 130, as shown in FIG. 10, reinforcing ribs are provided at the opposite sides of the first end plate 930 and the second stage plate 940, so as to structurally reinforce the first end plate 930 and the second stage plate 940.

In summary, in the technical solution in the embodiments of the present invention, the first electrode and second electrode at opposite sides of any adjacent sub-units are separated by the partition plate, preventing a short circuit for the first electrode and the second electrode; the primary mating protrusion and the primary mating recess form the primary sealing mating line with the effects of a good sealing effect, a simple production process and a low production cost; and due to the effects, at least one of the first liquid inlet channel, first liquid outlet channel, second liquid inlet channel and second liquid outlet channel, which are produced between adjacent frames by separation by the primary sealing mating line, also has the effects.

Although the embodiments of the present application have been shown and described above, it may be understood that the above-described embodiments are illustrative and are not to be construed as limiting the present application. Variations, modifications, substitutions, and alterations of the above-described embodiments may be made by those of ordinary skill in the art within the scope of the present application.

1. A flow battery comprising a plurality of subunits arranged in sequence, each of the subunits comprising a first electrode having a first cavity, a second electrode having a second cavity, a frame, a partition plate, and a proton exchange membrane, the proton exchange membrane being provided at an inner hole of the frame, the first electrode being located at a first side of the proton exchange membrane, the second electrode being located at a second side of the proton exchange membrane, and the partition plate being provided at a side of one of the first electrode and the second electrode facing away from the other one of the first electrode and the second electrode;
wherein the first electrode and the second electrode at opposite sides of any adjacent sub-units are separated by the partition plate, opposite sides of any adjacent frames are provided with a primary mating protrusion, a primary mating recess, a first liquid inlet channel, a first liquid outlet channel, a second liquid inlet channel and a second liquid outlet channel, the primary mating protrusion and the primary mating recess form a primary seal mating line, the first liquid inlet channel, the first cavity and the first liquid outlet channel are communicated, the second liquid inlet channel, the second cavity and the second liquid outlet channel are communicated, and at least one of the first liquid inlet channel, the first liquid outlet channel, the second liquid inlet channel and the second liquid outlet channel is produced by separation by the primary seal mating line.

2. The flow battery according to claim 1, wherein the primary mating protrusion comprises a first primary mating protrusion, a second primary mating protrusion, a third primary mating protrusion, and a fourth primary mating protrusion, the primary mating recess comprises a first primary mating recess, a second primary mating recess, a third primary mating recess, and a fourth primary mating recess, the first primary mating protrusion and the first primary mating recess form a first primary seal mating line, the second primary mating protrusion and the second primary mating recess form a second primary seal mating line, the third primary mating protrusion and the third primary mating recess form a third primary seal mating line, the fourth primary mating protrusion and the fourth primary mating recess form a fourth primary seal mating line, the first liquid inlet channel is produced by separation by the first primary seal mating line, the first liquid outlet channel is produced by separation by the second primary seal mating line, the second liquid inlet channel is produced by separation by the third primary seal mating line, and the second liquid outlet channel is produced by separation by the fourth primary seal mating line.

3. The flow battery according to claim 2, wherein the first primary mating recess, the second primary mating recess, the third primary mating recess, and the fourth primary mating recess are located at a first side of the frame, and the first primary mating protrusion, the second primary mating protrusion, the third primary mating protrusion, and the fourth primary mating protrusion are located at a second side of the frame.

4. The flow battery according to claim 1, wherein
a flow equalizing structure is provided between the first liquid inlet channel and the first cavity;/or
a flow equalizing structure is provided between the first cavity and the first liquid outlet channel;/or
a flow equalizing structure is provided between the second liquid inlet channel and the second cavity;/or
a flow equalizing structure is provided between the second cavity and the second liquid outlet channel.

5. The flow battery according to claim 1, wherein opposite sides of any adjacent frames are further provided with a secondary mating protrusion and a secondary mating recess, the secondary mating protrusion and the secondary mating recess form an annular sub-seal mating line, and the primary mating protrusion, the primary mating recess, the first liquid inlet channel, the first liquid outlet channel, the second liquid inlet channel, the second liquid outlet channel, the first electrode, and the second electrode are all located within a region surrounded by the sub-seal mating line.

6. The flow battery according claim 5, further comprising:
a first insulating plate and a second insulating plate, wherein the first insulating plate is located at a first side of the second insulating plate, a plurality of the subunits are located between the first insulating plate and the second insulating plate, a first liquid inlet channel, a first liquid outlet channel, a primary mating protrusion, a primary mating recess, a secondary mating protrusion, and a secondary mating recess are also provided between the first insulating plate and a frame adjacent thereto, and a second liquid inlet channel, a second liquid outlet channel, a primary mating protrusion, a primary mating recess, a secondary mating protrusion, and a secondary mating recess are also provided between the second insulating plate and a frame adjacent thereto.

7. The flow battery according to claim 5, wherein
the primary mating protrusion has a height of 4 mm ˜12 mm , and a width of 1.5 mm ˜3 mm , and the primary mating recess has a depth of 4 mm ˜12 mm , and a width of 2 mm ˜3.5 mm ;/or
the secondary mating protrusion has a height of 4 mm ˜12 mm and a width of 1.5 mm ˜3 mm , and the secondary mating recess has a depth of 4 mm ˜12 mm and a width of 2 mm ˜3.5 mm .

8. The flow battery according to claim 1, wherein the frame comprises a first frame and a second frame, one of the first frame and the second frame is provided with a positioning recess and the other one is provided with a positioning protrusion, one of the first frame and the second frame is further provided with an annular sealing rib, the positioning protrusion is disposed in the positioning recess, the sealing rib presses a periphery of the proton exchange membrane against the other one of the first frame and the second frame, the primary mating recess and the primary mating protrusion are located outside a region surrounded by the second frame and on the first frame, and the partition plate is provided at a side of the second frame opposite to the first frame.

9. The flow battery according to claim 8, wherein an elastic deformation structure for adjusting a size of the second frame is provided at a corner of the second frame.

10. The flow battery according to claim 8. wherein the locating protrusion has a height of 1.5 mm ˜3.5 mm, a width of 1.5 mm ˜3 mm , and the locating recess has a depth of 1.5 mm ˜3.5 mm , and a width of 2 mm ˜3.5 mm .
